(19) United States
(12) Patent Application Publication
(10) Pub. No.: US 2023/0246179 A1
(43) Pub. Date: Aug. 3, 2023

(54) LITHIUM-ION SECONDARY BATTERY

(71) Applicant: MURATA MANUFACTURING CO., LTD., Kyoto (JP)

(72) Inventor: Takumi HIASA, Kyoto (JP)

(21) Appl. No.: 18/118,465

(22) Filed: Mar. 7, 2023

Related U.S. Application Data
(63) Continuation of application No. PCT/JP2021/027133, filed on Jul. 20, 2021.

(30) Foreign Application Priority Data
Sep. 10, 2020 (JP) 2020-151932

(51) Int. Cl. H01M 4/48; H01M 10/0525; H01M 10/24

(52) U.S. Cl. CPC H01M 4/48; H01M 10/0525; H01M 10/24; H01M 2004/027

(57) ABSTRACT

A secondary battery includes a positive electrode, a negative electrode, and an electrolytic solution. The positive electrode is an electrode which a lithium ion is to be inserted into and extracted from. The negative electrode includes a negative electrode active material which the lithium ion is to be inserted into and extracted from. The electrolytic solution includes an aqueous solvent. The negative electrode active material includes a titanium-containing compound. The electrolytic solution has a pH that is higher than or equal to 11. Based on a surface analysis of the negative electrode by X-ray photoelectron spectroscopy, a proportion of a sum of respective detectable amounts of lithium, titanium, tin, zirconium, bismuth, and indium to a sum of respective detectable amounts of all of metal elements is greater than or equal to 99 atom %.

### CROSS REFERENCE TO RELATED APPLICATIONS

The present application is a continuation of PCT patent application no. PCT/JP2021/027133, filed on Jul. 20, 2021, which claims priority to Japanese patent application no. JP2020-151932, filed on Sep. 10, 2020, the entire contents of which are incorporated herein by reference.

### BACKGROUND

The present technology relates to a lithium-ion secondary battery.

Various kinds of electronic equipment, including mobile phones, have been widely used. Such widespread use has promoted development of a lithium-ion secondary battery as a power source that is smaller in size and lighter in weight and allows for a higher energy density. As such a lithium-ion secondary battery, a lithium-ion secondary battery including an electrolytic solution that includes an aqueous solvent, i.e., a so-called aqueous electrolytic solution, is being developed. A configuration of the lithium-ion secondary battery has been considered in various ways.

Specifically, in order to suppress electrolysis of an aqueous electrolytic solution upon charging and discharging, the aqueous electrolytic solution includes a lithium ion, an imide-based anion, and a metal cation, and has a pH within a range from 3 to 12 both inclusive. In order to achieve a self-standing electrode without current collector or binder, the self-standing electrode includes: a composite material having electrode active material particles in a three-dimensional cross-linked network of carbon nanotubes; and a battery tab secured to a body including the composite material. In order to obtain superior charge and discharge efficiency and superior storage performance, a negative electrode active material including a Ti-containing composite oxide is used, and an element such as Hg is present on a surface of a negative electrode including the negative electrode active material.

In order to achieve a flexible electrochemical cell, the electrochemical cell includes, as an electrode, a nonwoven fabric including a fibrous active electrode material. In order to ensure cycle stability, a negative electrode active material including a titanium oxide has a carbon coat layer on a surface thereof. In order to obtain excellent rate property, lithium titanate having macropores is used as an electrode active material of an electricity storage device.

### SUMMARY

The present technology relates to a lithium-ion secondary battery.

Although consideration has been given in various ways regarding a battery characteristic of a lithium-ion secondary battery including an aqueous electrolytic solution, a charge and discharge characteristic of the lithium-ion secondary battery is not sufficient yet. Accordingly, there is still room for improvement in terms thereof.

It is therefore desirable to provide a lithium-ion secondary battery that is able to achieve a superior charge and discharge characteristic.

A lithium-ion secondary battery according to an embodiment includes a positive electrode, a negative electrode, and an electrolytic solution. The positive electrode is an electrode which a lithium ion is to be inserted into and extracted from. The negative electrode includes a negative electrode active material which the lithium ion is to be inserted into and extracted from. The electrolytic solution includes an aqueous solvent. The negative electrode active material includes a titanium-containing compound. The electrolytic solution has a pH that is higher than or equal to 11. Based on a surface analysis of the negative electrode by X-ray photoelectron spectroscopy, a proportion of a sum of respective detectable amounts of lithium, titanium, tin, zirconium, bismuth, and indium to a sum of respective detectable amounts of all of metal elements is greater than or equal to 99 atom %.

Another lithium-ion secondary battery according to an embodiment includes a partition, a positive electrode, a negative electrode, a positive electrode electrolytic solution, and a negative electrode electrolytic solution. The partition is disposed between a positive electrode space and a negative electrode space, and allows a lithium ion to pass therethrough. The positive electrode is disposed in the positive electrode space and is an electrode which the lithium ion is to be inserted into and extracted from. The negative electrode is disposed in the negative electrode space and includes a negative electrode active material which the lithium ion is to be inserted into and extracted from. The positive electrode electrolytic solution is contained in the positive electrode space and includes an aqueous solvent. The negative electrode electrolytic solution is contained in the negative electrode space and includes the aqueous solvent. The negative electrode active material includes a titanium-containing compound. The positive electrode electrolytic solution has a pH that is lower than 11. The negative electrode electrolytic solution has a pH that is higher than or equal to 11. Based on a surface analysis of the negative electrode by X-ray photoelectron spectroscopy, a proportion of a sum of respective detectable amounts of lithium, titanium, tin, zirconium, bismuth, and indium to a sum of respective detectable amounts of all of metal elements is greater than or equal to 99 atom %.

Here, “all of metal elements” represent all of the metal elements that are analyzable or detectable by the X-ray photoelectron spectroscopy, and more specifically represent all of metal elements belonging to groups 1 to 17 in the long period periodic table of elements including lithium.

Further, in a case where the surface analysis of the negative electrode is performed by the X-ray photoelectron spectroscopy to calculate the above-described proportion, the surface of the negative electrode is analyzed at any 10 points. Thus, the proportion is an average value of 10 proportions calculated for the respective 10 points. Note that details of a procedure for performing analysis by the X-ray photoelectron spectroscopy and details of a procedure for calculating the proportion will be described later.

According to a lithium-ion secondary battery of an embodiment, the negative electrode active material included in the negative electrode includes the titanium-containing compound, the electrolytic solution including the aqueous solvent has the pH that is higher than or equal to 11, and the proportion based on the surface analysis of the negative electrode by the X-ray photoelectron spectroscopy is within the above-described range. Accordingly, it is possible to achieve a superior charge and discharge characteristic.

According to a lithium-ion secondary battery of an embodiment, the negative electrode active material included in the negative electrode includes the titanium-containing compound, the positive electrode electrolytic solution including the aqueous solvent has the pH that is lower than 11, the negative electrode electrolytic solution including the aqueous solvent has the pH that is greater than or equal to 11, and the proportion based on the surface analysis of the negative electrode by the X-ray photoelectron spectroscopy is within the above-described range. Accordingly, it is possible to achieve a superior charge and discharge characteristic.

Note that effects of the present technology are not necessarily limited to those described herein and may include any of a series of suitable effects described in relation to the present technology.

### BRIEF DESCRIPTION OF THE FIGURES

FIG. 1 is a sectional view of a configuration of a lithium-ion secondary battery according to an embodiment of the present technology.

FIG. 2 is a sectional view of a configuration of a lithium-ion secondary battery according to an embodiment of the present technology.

FIG. 3 is a sectional view of a configuration of a lithium-ion secondary battery according to an embodiment of the present technology.

FIG. 4 is a sectional view of a configuration of a lithium-ion secondary battery according to an embodiment of the present technology.

### DETAILED DESCRIPTION

One or more embodiments of the present technology are described below in further detail including with reference to the drawings.

A description is given of a lithium-ion secondary battery according to an embodiment of the present technology.

The lithium-ion secondary battery to be described here is a secondary battery utilizing insertion and extraction of a lithium ion. The lithium-ion secondary battery includes a positive electrode, a negative electrode, and an electrolytic solution that is a liquid electrolyte including an aqueous solvent, i.e., an aqueous electrolytic solution. The lithium-ion secondary battery utilizes insertion and extraction of the lithium ion to allow charging and discharging reactions to proceed, thereby obtaining a battery capacity.

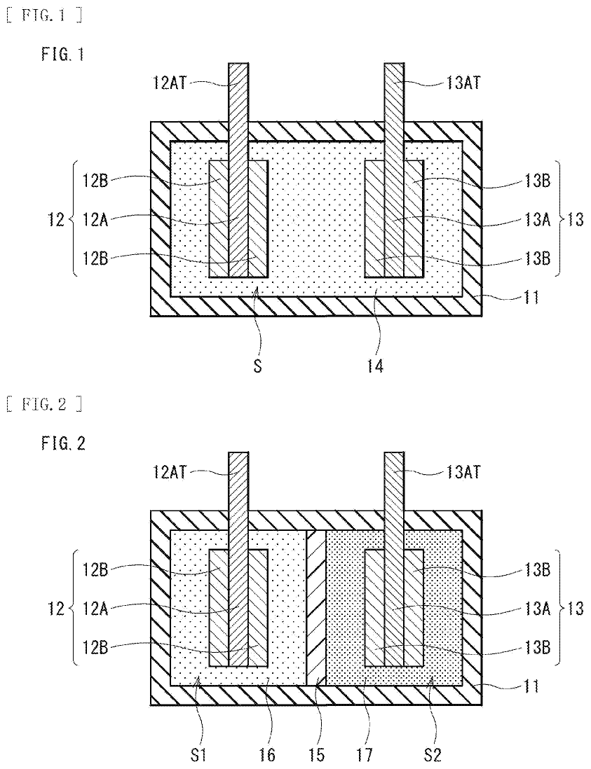

FIG. 1 illustrates a sectional configuration of a lithium-ion secondary battery according to an embodiment. As illustrated in FIG. 1, the lithium-ion secondary battery includes an outer package member 11, a positive electrode 12, a negative electrode 13, and an electrolytic solution 14. In FIG. 1, the electrolytic solution 14 is lightly shaded.

In the following description, an upper side in FIG. 1 represents an upper side of the lithium-ion secondary battery and a lower side in FIG. 1 represents a lower side of the lithium-ion secondary battery.

The outer package member 11 is a generally box-shaped member having an internal space S for containing components including, without limitation, the positive electrode 12, the negative electrode 13, and the electrolytic solution 14.

The outer package member 11 includes one or more of materials including, without limitation, a metal material, a glass material, and a polymer compound. Specifically, the outer package member 11 may be, but not limited to, a rigid metal can, a rigid glass case, a rigid plastic case, a soft or flexible metal foil, or a soft or flexible polymer film.

The positive electrode 12 is disposed in the internal space S, and allows the lithium ion to be inserted thereinto and extracted therefrom. Here, the positive electrode 12 includes a positive electrode current collector 12A having two opposed surfaces, and a positive electrode active material layer 12B provided on each of the two opposed surfaces of the positive electrode current collector 12A. However, the positive electrode active material layer 12B may be provided only on one of the two opposed surfaces of the positive electrode current collector 12A, on a side where the positive electrode 12 is opposed to the negative electrode 13.

Note that the positive electrode current collector 12A is omittable. Therefore, the positive electrode 12 may include only the positive electrode active material layer 12B.

The positive electrode current collector 12A supports the positive electrode active material layer 12B, and includes one or more of electrically conductive materials including, without limitation, a metal material, a carbon material, and an electrically conductive ceramic material. Specific examples of the metal material include titanium, aluminum, and an alloy thereof. Specific examples of the electrically conductive ceramic material include indium tin oxide (ITO). Here, the positive electrode active material layer 12B is not provided on a portion of the positive electrode current collector 12A, i.e., a coupling terminal part 12AT, and the coupling terminal part 12AT is led out of the outer package member 11.

In particular, the positive electrode current collector 12A preferably includes a material that is insoluble or sparingly soluble in and resistant to corrosion by the electrolytic solution 14, and that has low reactivity to the positive electrode active material. Therefore, the positive electrode current collector 12A preferably includes any of the above-described metal materials. That is, the positive electrode current collector 12A preferably includes a material such as titanium, aluminum, or an alloy thereof. A reason for this is that degradation of the positive electrode current collector 12A is thereby suppressed even if the lithium-ion secondary battery is used.

The positive electrode current collector 12A may be an electric conductor having a surface covered with plating of one or more materials among the metal material, the carbon material, and the electrically conductive ceramic material described above. The electric conductor is not limited to a particular material as long as the material is electrically conductive.

The positive electrode active material layer 12B includes one or more of positive electrode active materials which the lithium ion is to be inserted into and extracted from. Note that the positive electrode active material layer 12B may further include a material such as a positive electrode binder or a positive electrode conductor.

The positive electrode active material includes, for example, a lithium-containing compound. The lithium-containing compound is not limited to a particular kind, and specific examples thereof include a lithium composite oxide and a lithium phosphoric acid compound. The lithium composite oxide is an oxide that includes lithium and one or more transition metal elements as constituent elements. The lithium phosphoric acid compound is a phosphoric acid compound that includes lithium and one or more transition metal elements as constituent elements. The transition metal elements are not limited to particular kinds, and specific examples thereof include nickel, cobalt, manganese, and iron.

Specific examples of the lithium composite oxide having a layered rock-salt crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.102}, and Li_{1.15}(Mn_{0.65}Ni_{0.22}Co_{0.13})O₂. Specific examples of the lithium composite oxide having a spinel crystal structure include LiMn₂O₄. Specific examples of the lithium phosphoric acid compound having an olivine crystal structure include LiFePO₄, LiMnPO₄, LiMn_{0.5}Fe_{0.5}PO₄, LiMn_{0.7}Fe_{0.3}PO₄, and LiMn_{0.75}Fe_{0.25}PO₄.

The positive electrode binder includes one or more of materials including, without limitation, a synthetic rubber and a polymer compound. Specific examples of the synthetic rubber include a styrene-butadiene-based rubber. Specific examples of the polymer compound include polyvinylidene difluoride and polyimide.

The positive electrode conductor includes one or more of electrically conductive materials including, without limitation, a carbon material. Specific examples of the carbon material include graphite, carbon black, acetylene black, and Ketjen black. Note that the electrically conductive material may be a material such as a metal material, an electrically conductive ceramic material, or an electrically conductive polymer.

The negative electrode 13 is disposed in the internal space S in such a manner as to be separated from the positive electrode 12, and allows the lithium ion to be inserted thereinto and extracted therefrom. Here, the negative electrode 13 includes a negative electrode current collector 13A having two opposed surfaces, and a negative electrode active material layer 13B provided on each of the two opposed surfaces of the negative electrode current collector 13A. However, the negative electrode active material layer 13B may be provided only on one of the two opposed surfaces of the negative electrode current collector 13A on a side where the negative electrode 13 is opposed to the positive electrode 12.

The negative electrode current collector 13A, the negative electrode active material layer 13B, or each of the negative electrode current collector 13A and the negative electrode active material layer 13B that are included in the negative electrode 13 includes a particular metal material on the surface thereof. Such a negative electrode 13 thus exhibits a property of not easily reacting with and dissolving in the electrolytic solution 14 which is strongly alkaline to be described later. The particular metal material is a material including a particular kind of metal element as a constituent element, and more specifically a material including one or more of titanium, tin, zirconium, bismuth, or indium as one or more constituent elements. Only one kind of particular metal material may be used, or two or more kinds of particular metal materials may be used.

Note that the particular metal material may be a simple substance (a simple substance of a metal), an alloy, an oxide (a metal oxide which is a conducting object), or may include two or more thereof. Specific examples of the oxide include an oxide including one or more of the above-described metal elements such as titanium as one or more constituent elements, and more specific examples thereof include titanium oxide.

In contrast, out of the negative electrode current collector 13A and the negative electrode active material layer 13B that are included in the negative electrode 13, the negative electrode current collector 13A, the negative electrode active material layer 13B, or each of the negative electrode current collector 13A and the negative electrode active material layer 13B may include a non-particular metal material on the surface thereof. In such a case, the negative electrode 13 exhibits a property of easily reacting with and dissolving in the electrolytic solution 14 which is strongly alkaline. The non-particular metal material is a material including a metal element other than the above-described particular metal element as a constituent element, and more specifically a material including one or more of aluminum, copper, lead, zinc, magnesium, or iron as one or more constituent elements.

A reason why the negative electrode current collector 13A, the negative electrode active material layer 13B, or each of the negative electrode current collector 13A and the negative electrode active material layer 13B includes the particular metal material on the surface thereof is as follows. In a case where an appropriate condition related to an element proportion A to be described later is satisfied, the negative electrode 13 is prevented from easily reacting with and easily dissolving in the electrolytic solution 14 which is strongly alkaline, which prevents a constituent atom of the negative electrode 13 from being eluted easily into the electrolytic solution 14. This suppresses degradation and decomposition of the electrolytic solution 14, and thus prevents a charge and discharge characteristic of the lithium-ion secondary battery from being lowered easily. Details of the element proportion A will be described later.

In particular, the negative electrode current collector 13A, the negative electrode active material layer 13B, or each of the negative electrode current collector 13A and the negative electrode active material layer 13B preferably includes on the surface thereof, as the particular metal material, a material including titanium as a constituent element. A reason for this is that this sufficiently prevents the negative electrode 13 from easily reacting with and easily dissolving in the electrolytic solution 14 which is strongly alkaline, and thus sufficiently suppresses the degradation and the decomposition of the electrolytic solution 14.

In particular, each of the negative electrode current collector 13A and the negative electrode active material layer 13B preferably includes the particular metal material on the surface thereof, and more preferably includes the material including titanium as a constituent element on the surface thereof. A reason for this is that this further prevents the negative electrode 13 from easily reacting with and easily dissolving in the electrolytic solution 14 which is strongly alkaline, and thus further suppresses the degradation and the decomposition of the electrolytic solution 14.

Further, in a case where only one of the negative electrode current collector 13A or the negative electrode active material layer 13B includes the particular metal material on the surface thereof, the negative electrode current collector 13A preferably includes the particular metal material on the surface thereof, and more preferably includes the material including titanium as a constituent element on the surface thereof. A reason for this is that the negative electrode current collector 13A has a high affinity with a negative electrode active material (a titanium-containing compound to be described later), and this makes it easier for the negative electrode active material layer 13B to stably adhere to the negative electrode current collector 13A, and also allows charging and discharging reactions to easily proceed stably in the negative electrode active material layer 13B.

Note that the surface of the negative electrode current collector 13A, the negative electrode active material layer 13B, or each of the negative electrode current collector 13A and the negative electrode active material layer 13B may be covered with the particular metal material. In this case, the surface of the negative electrode current collector 13A, the negative electrode active material layer 13B, or each of the negative electrode current collector 13A and the negative electrode active material layer 13B may be plated with the particular metal material.

In addition, as long as the negative electrode current collector 13A, the negative electrode active material layer 13B, or each of the negative electrode current collector 13A and the negative electrode active material layer 13B includes the particular metal material, it may further include the non-particular metal material, or may further include a material other than the non-particular metal material.

The negative electrode current collector 13A supports the negative electrode active material layer 13B, and includes one or more of electrically conductive materials. Examples of the electrically conductive material include a metal material, a carbon material, and an electrically conductive ceramic material. Specific examples of the metal material include stainless steel (SUS), titanium, zinc, tin, lead, and an alloy of two or more thereof.

Here, the negative electrode active material layer 13B is not provided on a portion of the negative electrode current collector 13A, i.e., a coupling terminal part 13AT, and the coupling terminal part 13AT is led out of the outer package member 11. A direction in which the coupling terminal part 13AT is led out is not particularly limited, and is specifically similar to a direction in which the coupling terminal part 12AT is led out.

The negative electrode active material layer 13B includes one or more of negative electrode active materials which the lithium ion is to be inserted into and extracted from. Note that the negative electrode active material layer 13B may further include a material such as a negative electrode binder or a negative electrode conductor. Details of the negative electrode binder are similar to those of the positive electrode binder. Details of the negative electrode conductor are similar to those of the positive electrode conductor. Note that, in a case where the negative electrode conductor is the metal material, the metal material preferably includes the above-described particular metal material on the surface thereof.

The negative electrode active material includes one or more of the titanium-containing compounds. A reason for this is that this allows the charging and discharging reactions to easily proceed smoothly and stably even if the electrolytic solution 14 which is strongly alkaline is used. The negative electrode active material preferably includes the above-described particular metal material on the surface thereof.

The term “titanium-containing compound” is a generic term for a compound including titanium as a constituent element, and specific examples thereof include a titanium oxide, a lithium-titanium composite oxide, a titanium phosphoric acid compound, a lithium titanium phosphoric acid compound, and a hydrogen titanium compound.

The titanium oxide includes a compound (so-called titanium oxide) represented by Formula (1), i.e., titanium oxide of a bronze type, for example.

TiO_{w} (1)

where w satisfies 1.85≤w≤2.15.

The titanium oxide above includes one or more of titanium oxide (TiO₂) of an anatase type, titanium oxide (TiO₂) of a rutile type, or titanium oxide (TiO₂) of a brookite type. However, the titanium oxide may be a composite oxide including one or more of elements including, without limitation, phosphorus, vanadium, tin, copper, nickel, iron, and cobalt as one or more constituent elements together with titanium. Specific examples of such a composite oxide include TiO₂—P₂O₅, TiO₂—V₂O₅, TiO₂—P₂O₅—SnO₂, and TiO₂—P₂O₅-MeO, where Me is one or more of elements including, without limitation, Cu, Ni, Fe, and Co.

In particular, the titanium oxide is preferably titanium oxide of the anatase type. A reason for this is that titanium oxide of the anatase type is stable with respect to the electrolytic solution 14 which is strongly alkaline, and this helps the lithium-ion secondary battery to operate stably, i.e., allows the lithium-ion secondary battery to be charged and discharged stably.

The lithium-titanium composite oxide includes one or more of respective compounds represented by Formulae (2) to (4), i.e., lithium titanate of a ramsdellite type. M1 in Formula (2) is a metal element that is to be a divalent ion. M2 in Formula (3) is a metal element that is to be a trivalent ion. M3 in Formula (4) is a metal element that is to be a tetravalent ion.

Li[LiₓM1_{(1-3x)/2}Ti_{(3+x)/2}]O₄ (2)

where:
M1 is at least one of Mg, Ca, Cu, Zn, or Sr; and
x satisfies 0≤x≤⅓.

Li[Li_{y}M2_{1-3y}Ti_{1+2y}]O₄ (3)

where:
M2 is at least one of Al, Sc, Cr, Mn, Fe, Ge, or Y; and
y satisfies 0≤y≤⅓.

Li[Li_{1/3}M3_{z}Ti_{(5/3)-z}]O₄ (4)

where:
M3 is at least one of V, Zr, or Nb; and
z satisfies 0≤z≤⅔.

Specific examples of the compound represented by Formula (2) include Li_{3.75}Ti_{4.875}Mg_{0.375}O₁₂. Specific examples of the compound represented by Formula (3) include LiCrTiO₄. Specific examples of the compound represented by Formula (4) include Li₄Ti₅O₁₂ and Li₄Ti_{4.95}Nb_{0.05}O₁₂.

Specific examples of the titanium phosphoric acid compound include titanium phosphate (TiP₂O₇). Specific examples of the lithium titanium phosphoric acid compound include LiTi₂(PO₄)₃. Specific examples of the hydrogen titanium compound include H₂Ti₃O₇(3TiO₂·1H₂O), H₆Ti₁₂O₂₇(3TiO₂·0.75H₂O), H₂Ti₆O₁₃(3TiO₂·0.5H₂O), H₂Ti₇O₁₅(3TiO₂·0.43H₂O), and H₂Ti₁₂O₂₅(3TiO₂·0.25H₂O).

In particular, the titanium-containing compound is preferably the titanium oxide, the lithium-titanium composite oxide, or both, and is more preferably the titanium oxide. A reason for this is that this allows the charging and discharging reactions to proceed sufficiently even if the electrolytic solution 14 which is strongly alkaline is used.

Note that the negative electrode active material may further include, together with the above-described titanium-containing compound, one or more of other compounds each including no titanium as a constituent element. The other compounds are not limited to particular kinds, and examples thereof include an alkali-metal-titanium composite oxide (note that the above-described lithium-titanium composite oxide is excluded), an alkali metal titanium phosphoric acid compound (note that the above-described lithium-titanium composite oxide is excluded), a niobium-containing compound, a vanadium-containing compound, an iron-containing compound, and a molybdenum-containing compound.

Examples of the niobium-containing compound include a lithium-niobium composite oxide, a hydrogen niobium compound, and a titanium-niobium composite oxide. Note that a material belonging to the niobium-containing compound is excluded from the titanium-containing compound. Specific examples of the lithium-niobium composite oxide include LiNbO₂. Specific examples of the hydrogen niobium compound include H₄Nb₆O₁₇. Specific examples of the titanium-niobium composite oxide include TiNb₂O₇ and Ti₂Nb₁₀O₂₉. The titanium-niobium composite oxide may be intercalated with lithium.

Examples of the vanadium-containing compound include a vanadium oxide and an alkali-metal-vanadium composite oxide. Note that a material belonging to the vanadium-containing compound is excluded from each of the titanium-containing compound and the niobium-containing compound. Specific examples of the vanadium oxide include vanadium dioxide (VO₂). Specific examples of a lithium-vanadium composite oxide which is the alkali-metal-vanadium composite oxide include LiV₂O₄ and LiV₃O₈.

Examples of the iron-containing compound include iron hydroxide. Note that a material belonging to the iron-containing compound is excluded from each of the titanium-containing compound, the niobium-containing compound, and the vanadium-containing compound. Specific examples of the iron hydroxide include iron oxyhydroxide (FeOOH). The iron oxyhydroxide may be α-iron oxyhydroxide, β-iron oxyhydroxide, γ-iron oxyhydroxide, iron oxyhydroxide, or any two or more thereof.

Examples of the molybdenum-containing compound include a molybdenum oxide and a cobalt-molybdenum composite oxide. Note that a material belonging to the molybdenum-containing compound is excluded from each of the titanium-containing compound, the niobium-containing compound, the vanadium-containing compound, and the iron-containing compound. Specific examples of the molybdenum oxide include molybdenum dioxide (MoO₂). Specific examples of the cobalt-molybdenum composite oxide include CoMoO₄.

Note that the negative electrode 13 may include the carbon material or may not necessarily include the carbon material. Examples of the case where the negative electrode 13 includes the carbon material to be described here include: a case where the negative electrode current collector 13A includes carbon as a constituent element; a case where the negative electrode current collector 13A includes a carbon covering layer; a case where the negative electrode active material layer 13B includes the carbon material as the negative electrode conductor; a case where the negative electrode active material layer 13B includes the carbon covering layer; and a case where the negative electrode active material includes the carbon covering layer.

Note that the carbon covering layer may cover the entire surface of the negative electrode current collector 13A or may cover only a portion of the surface of the negative electrode current collector 13A. In the latter case, multiple carbon covering layers may cover the surface of the negative electrode current collector 13A at respective locations separated from each other. Details related to a range over which the carbon covering layer covers described here are similar to those for a case where the carbon covering layer covers the surface of the negative electrode active material layer 13B and a case where the carbon covering layer covers a surface of the negative electrode active material layer.

In particular, it is preferable that the negative electrode 13 include no carbon material. A reason for this is that the carbon material has a low hydrogen overvoltage, and this causes the aqueous solvent included in the electrolytic solution 14 to decompose easily on the surface of the negative electrode 13 if the carbon material is included in the negative electrode 13. It is therefore preferable that the negative electrode 13 include no carbon material in order to suppress the decomposition reaction of the aqueous solvent.

However, in the case where the negative electrode 13 includes the carbon material, it is preferable that a content of the carbon material in the negative electrode 13 be as small as possible. Specifically, a proportion of a weight of the carbon material to a weight of the negative electrode 13, i.e., a carbon proportion C (wt %), is preferably less than 0.1 wt %. A reason for this is that this prevents the aqueous solvent from decomposing easily on the surface of the negative electrode 13. The carbon proportion C is calculated on the basis of the following calculation expression: carbon proportion C (wt %)=(weight of carbon material/weight of negative electrode 13)×100. A value of the carbon proportion C is rounded off to one decimal place.

The electrolytic solution 14 is contained in the internal space S, and is an aqueous electrolytic solution including the aqueous solvent as described above. In other words, the electrolytic solution 14 is a solution in which an ionic material ionizable in the aqueous solvent is dissolved or dispersed in the aqueous solvent.

Specifically, the electrolytic solution 14 includes the aqueous solvent and one or more of ionic materials that are ionizable in the aqueous solvent. More specifically, the electrolytic solution 14 includes the lithium ion that is to be inserted into and extracted from each of the positive electrode 12 and the negative electrode 13.

The aqueous solvent is not limited to a particular kind, and specific examples thereof include pure water. The ionic material is not limited to a particular kind, and specifically includes one or more of materials including, without limitation, an acid, a base, and an electrolyte salt. Specific examples of the acid include carbonic acid, oxalic acid, nitric acid, sulfuric acid, hydrochloric acid, acetic acid, and citric acid.

The electrolyte salt is a salt including a cation and an anion. More specifically, the electrolyte salt includes one or more of lithium salts. Specific examples of the lithium salt include lithium carbonate, lithium oxalate, lithium nitrate, lithium sulfate, lithium chloride, lithium acetate, lithium citrate, lithium hydroxide, and an imide salt. Examples of the imide salt include lithium bis(fluorosulfonyl)imide and lithium bis(trifluoromethane sulfonyl)imide.

In particular, as described above, the electrolytic solution 14 has a pH that is higher than or equal to 11, and is therefore strongly alkaline. A reason for this is that this makes it easier for the lithium ion to move in the electrolytic solution 14, and thus allows the charging and discharging reactions proceed easily. A value of the pH is rounded off to the nearest whole number, and the definition of the value of the pH described here applies also to the description below.

Accordingly, the electrolyte salt is preferably a material such as lithium hydroxide in particular. A reason for this is that this makes it easier to make the pH of the electrolytic solution 14 to be higher than or equal to 11, and to easily and stably achieve the electrolytic solution 14 which is strongly alkaline.

A content of the ionic material, i.e., a concentration (mol/kg) of the electrolytic solution 14, is not particularly limited, and may thus be set as desired. Specifically, the concentration of the electrolytic solution 14 is preferably within a range from 0.2 mol/kg to 4 mol/kg both inclusive. A reason for this is that this easily and stably achieves the electrolytic solution 14 which is strongly alkaline.

Note that the electrolyte salt may further include one or more of other metal salts in addition to the above-described lithium salt. The other metal salt is not limited to a particular kind, and specific examples thereof include an alkali metal salt (excluding the lithium salt), an alkaline earth metal salt, and a transition metal salt. Specific examples of the alkali metal salt include a sodium salt and a potassium salt. Specific examples of the alkaline earth metal salt include a calcium salt and a magnesium salt.

Here, it is more preferable that the electrolytic solution 14 be a saturated solution of the electrolyte salt. A reason for this is that this facilitates stable insertion and extraction of the lithium ion upon charging and discharging, which makes it easier for the charging and discharging reactions to proceed stably.

In order to check whether the electrolytic solution 14 is the saturated solution of the electrolyte salt, the lithium-ion secondary battery may be disassembled, following which whether the electrolyte salt is deposited in the internal space S may be checked. Specific examples of the internal space S include a location in the electrolytic solution 14, a location on a surface of the positive electrode 12, and a location on an inner wall surface of the outer package member 11. If the electrolyte salt is deposited and the electrolytic solution 14, which is a liquid, and the deposited matter of the electrolyte salt, which is a solid, therefore coexist in the internal space S, it is conceivable that the electrolytic solution 14 is a saturated solution of the electrolyte salt. In order to examine a composition of the deposited matter, a surface analysis method such as X-ray photoelectron spectroscopy (XPS) is usable, or a composition analysis method such as inductively coupled plasma (ICP) optical emission spectroscopy is usable.

In the lithium-ion secondary battery, a physical property of the negative electrode 13 is made appropriate in order to achieve a superior charge and discharge characteristic.

Specifically, based on a surface analysis of each of the negative electrode active material layer 13B and the negative electrode current collector 13A by XPS, a proportion of a detectable amount of a second element group to a detectable amount of a first element group, i.e., an element proportion A (atom %), is greater than or equal to 99 atom %.

Here, the first element group includes a series of metal elements that may be constituent elements of each of the negative electrode current collector 13A and the negative electrode active material layer 13B, and more specifically includes all of metal elements belonging to groups 1 to 17 in the long period periodic table of elements including lithium, as described above. Thus, the detectable amount of the first element group is a sum total of respective detectable amounts of all of the metal elements.

In contrast, the second element group includes, out of the series of metal elements that may be the constituent elements of each of the negative electrode current collector 13A and the negative electrode active material layer 13B: a series of metal elements to be included in the particular metal material described above; and lithium. The series of metal elements includes one or more of titanium, tin, zirconium, bismuth, or indium, as described above.

Thus, the detectable amount of the second element group is a sum total of: a sum of respective detectable amounts of one or more of titanium, tin, zirconium, bismuth, or indium; and a detectable amount of lithium.

Accordingly, the element proportion A is calculated on the basis of the following calculation expression: element proportion A (atom %)=(detectable amount of second element group/detectable amount of first element group)×100. A value of the element proportion A is rounded off to the nearest whole number.

Note that a reason why lithium is included in both the first element group and the second element group is that the lithium ion is inserted into the negative electrode 13 in the lithium-ion secondary battery, and this may cause lithium to be detected in a case where the surface of the negative electrode active material layer 13B is analyzed by XPS, and may cause lithium to be detected in a case where the surface of the negative electrode current collector 13A is analyzed by XPS.

Note that the element proportion A is an average value calculated on the basis of a result of the surface analysis of the negative electrode 13 by XPS, as described above. In a case of analyzing the surface of the negative electrode 13 by XPS, the surface of the negative electrode 13 is analyzed at any 10 points. The element proportion A is therefore the average value of 10 element proportions A calculated for the respective 10 points described above.

Here, as described above, the negative electrode 13 includes the negative electrode current collector 13A and the negative electrode active material layer 13B. In this case, the element proportion A is calculated by the following procedure.

Specifically, in a case of analyzing the respective surfaces of the negative electrode active material layer 13B and the negative electrode current collector 13A by XPS, the surface of the negative electrode active material layer 13B is analyzed at any nine points, and the surface of the negative electrode current collector 13A is analyzed at any one point.

Any nine points of the surface of the negative electrode active material layer 13B are nine locations that are sufficiently separated from each other on the surface of the negative electrode active material layer 13B. Any one point of the surface of the negative electrode current collector 13A is a portion of the negative electrode current collector 13A where no negative electrode active material layer 13B is provided (e.g., the coupling terminal part 13AT).

Thus, the element proportion A is the average value of 10 element proportions A obtained by adding up nine element proportions A calculated for the nine points of the negative electrode active material layer 13B and one element proportion A calculated for one point of the negative electrode current collector 13A.

A reason why the element proportion A is greater than or equal to 99 atom % is that, regarding a constituent material or a constituent element of the surface of the negative electrode 13 (each of the negative electrode current collector 13A and the negative electrode active material layer 13B), an abundance of the metal element to be included in the particular metal material becomes sufficiently large relative to an abundance of the metal element to be included in the non-particular metal material. Thus, the constituent atom of the negative electrode 13 is prevented from being eluted into the electrolytic solution 14 which is strongly alkaline, which suppresses the degradation and the decomposition of the electrolytic solution 14. This allows the charging and discharging reactions to easily proceed stably even if the electrolytic solution 14 which is strongly alkaline is used, and prevents a discharge capacity from decreasing easily even if charging and discharging are repeated.

Note that, in a case of calculating the element proportion A on the basis of the result of the surface analysis of each of the negative electrode active material layer 13B and the negative electrode current collector 13A by XPS, commercially available analysis software may be used. The analysis software is not limited to a particular kind, and specific examples thereof include SpecSurf available from JEOL Ltd., which calculates an atomic fraction on the basis of a peak area of an XPS spectrum of each constituent element.

In particular, based on the surface analysis of each of the negative electrode active material layer 13B and the negative electrode current collector 13A by XPS, a proportion of a detectable amount of a third element group to the detectable amount of the first element group, i.e., an element proportion B (atom %), is preferably greater than or equal to 99 atom %.

The third element group includes: titanium out of the series of metal elements to be included in the particular metal material described above; and lithium. Thus, the detectable amount of the third element group is a sum total of a detectable amount of titanium and the detectable amount of lithium.

Accordingly, the element proportion B is calculated on the basis of the following calculation expression: element proportion B (atom %)=(detectable amount of third element group/detectable amount of first element group)×100. A value of the element proportion B is rounded off to the nearest whole number.

Note that, as with the element proportion A described above, the element proportion B is an average value calculated on the basis of the result of the surface analysis of the negative electrode 13 (each of the negative electrode current collector 13A and the negative electrode active material layer 13B) by XPS.

A reason why the element proportion B is greater than or equal to 99 atom % is that the constituent atom of the negative electrode 13 is further prevented from being eluted into the electrolytic solution 14 which is strongly alkaline, which further suppresses the degradation and the decomposition of the electrolytic solution 14. This allows the charging and discharging reactions to easily proceed further stably even if the electrolytic solution 14 which is strongly alkaline is used, and further prevents the discharge capacity from decreasing easily even if charging and discharging are repeated.

Note that, in a case of calculating the element proportion B on the basis of the result of the surface analysis of each of the negative electrode active material layer 13B and the negative electrode current collector 13A by XPS, a procedure similar to the procedure for calculating the element proportion A is used.

Upon charging the lithium-ion secondary battery, when the lithium ion is extracted from the positive electrode 12, the extracted lithium ion moves through the electrolytic solution 14 to the negative electrode 13. Thus, the lithium ion is inserted into the negative electrode 13.

Upon discharging the lithium-ion secondary battery, when the lithium ion is extracted from the negative electrode 13, the extracted lithium ion moves through the electrolytic solution 14 to the positive electrode 12. Thus, the lithium ion is inserted into the positive electrode 12.

In a case of manufacturing the lithium-ion secondary battery, the positive electrode 12 and the negative electrode 13 are each fabricated and the electrolytic solution 14 is prepared, following which the lithium-ion secondary battery is fabricated, as described below.

First, the positive electrode active material, the positive electrode binder, and the positive electrode conductor are mixed with each other to thereby obtain a positive electrode mixture. Thereafter, the positive electrode mixture is put into a solvent to thereby prepare a paste positive electrode mixture slurry. The solvent may be an aqueous solvent, or may be an organic solvent. Lastly, the positive electrode mixture slurry is applied on the two opposed surfaces of the positive electrode current collector 12A (excluding the coupling terminal part 12AT), following which the applied positive electrode mixture slurry is dried to thereby form the positive electrode active material layers 12B. Thereafter, the positive electrode active material layers 12B may be compression-molded by means of, for example, a roll pressing machine. In this case, the positive electrode active material layers 12B may be heated. The positive electrode active material layers 12B may be compression-molded multiple times. Thus, the positive electrode 12 is fabricated.

The negative electrode active material layers 13B are formed on the respective two opposed surfaces of the negative electrode current collector 13A by a procedure similar to the procedure for fabricating the positive electrode 12 described above. Specifically, the negative electrode active material including the titanium-containing compound, the negative electrode binder, and the negative electrode conductor are mixed with each other to thereby obtain a negative electrode mixture. Thereafter, the negative electrode mixture is put into the solvent to thereby prepare a paste negative electrode mixture slurry. Thereafter, the negative electrode mixture slurry is applied on the two opposed surfaces of the negative electrode current collector 13A (excluding the coupling terminal part 13AT), following which the applied negative electrode mixture slurry is dried to thereby form the negative electrode active material layers 13B. Thereafter, the negative electrode active material layers 13B may be compression-molded. Thus, the negative electrode 13 is fabricated.

The ionic material is added to the aqueous solvent. The ionic material is thereby dispersed or dissolved in the aqueous solvent. As a result, the electrolytic solution 14 is prepared. In this case, conditions including, without limitation, a kind and a concentration (mol/kg) of the ionic material are adjusted to thereby set the pH of the electrolytic solution 14 to be higher than or equal to 11.

First, the positive electrode 12 and the negative electrode 13 are placed into the internal space S of the outer package member 11. In this case, the coupling terminal parts 12AT and 13AT are each led out of the outer package member 11.

Thereafter, the electrolytic solution 14 is supplied into the internal space S through an unillustrated injection hole that is in communication with the internal space S. The internal space S is thereby filled with the electrolytic solution 14. Thereafter, the injection hole is sealed.

Thus, the electrolytic solution 14 is contained in the internal space S in which the positive electrode 12 and the negative electrode 13 are each disposed. As a result, the lithium-ion secondary battery including one aqueous electrolytic solution (i.e., the electrolytic solution 14) is completed.

According to the lithium-ion secondary battery, the negative electrode active material included in the negative electrode 13 includes the titanium-containing compound, the electrolytic solution 14 including the aqueous solvent has the pH that is higher than or equal to 11, and the element proportion A is greater than or equal to 99 atom %.

In this case, as described above, making the element proportion A appropriate prevents the constituent atom of the negative electrode 13 from being eluted easily into the electrolytic solution 14 which is strongly alkaline, and this suppresses the degradation and the decomposition of the electrolytic solution 14. This allows the charging and discharging reactions to proceed stably even if the electrolytic solution 14 which is strongly alkaline is used together with the negative electrode 13 including the titanium-containing compound, and prevents the discharge capacity from decreasing easily even if charging and discharging are repeated. Accordingly, it is possible to achieve a superior charge and discharge characteristic.

In particular, the element proportion B may be greater than or equal to 99 atom %. This further prevents the constituent atom of the negative electrode 13 from being eluted easily into the electrolytic solution 14 which is strong alkaline. Accordingly, it is possible to achieve higher effects.

Further, the negative electrode 13 may include the carbon material, and the carbon proportion C may be less than 0.1 wt %. This further suppresses the degradation and the decomposition of the electrolytic solution 14. Accordingly, it is possible to achieve higher effects.

Further, the concentration of the electrolytic solution 14 may be within the range from 0.2 mol/kg to 4 mol/kg both inclusive. This easily and stably achieves the electrolytic solution 14 which is strongly alkaline. Accordingly, it is possible to achieve higher effects.

Further, the titanium-containing compound may include the titanium oxide, the lithium-titanium composite oxide, or both. This allows the charging and discharging reactions to proceed sufficiently even if the electrolytic solution 14 which is strongly alkaline is used. Accordingly, it is possible to achieve higher effects.

In this case, the titanium oxide may include titanium oxide of the anatase type. This helps to obtain a high voltage. Accordingly, it is possible to achieve higher effects.

Further, the negative electrode 13 may include the negative electrode active material layer 13B, and the surface of the negative electrode active material layer 13B may be analyzed by XPS. This sufficiently prevents a constituent atom of the negative electrode active material layer 13B from being eluted easily into the electrolytic solution 14 which is strongly alkaline. Accordingly, it is possible to achieve higher effects.

In this case, the negative electrode 13 may further include the negative electrode current collector 13A, and the surface of the negative electrode active material layer 13B and the surface of the negative electrode current collector 13A may each be analyzed by XPS. This prevents not only the constituent atom of the negative electrode active material layer 13B but also a constituent atom of the negative electrode current collector 13A from being eluted easily into the electrolytic solution 14 which is strongly alkaline. Accordingly, it is possible to achieve further higher effects.

Next, a description is given of a lithium-ion secondary battery according to an embodiment of the present technology.

FIG. 2 illustrates a sectional configuration of the lithium-ion secondary battery according an embodiment. The lithium-ion secondary battery according to an embodiment has a configuration similar to the configuration (FIG. 1) of the lithium-ion secondary battery according to an embodiment described above except for those described below.

As illustrated in FIG. 2, the lithium-ion secondary battery further includes a partition 15, and includes a positive electrode electrolytic solution 16 and a negative electrode electrolytic solution 17 in place of the electrolytic solution 14. In FIG. 2, the positive electrode electrolytic solution 16 is lightly shaded, and the negative electrode electrolytic solution 17 is darkly shaded.

The outer package member 11 has two spaces which are separated from each other by the partition 15. The two spaces are a positive electrode compartment S1 serving as a positive electrode space and a negative electrode compartment S2 serving as a negative electrode space.

The partition 15 is disposed between the positive electrode 12 and the negative electrode 13, and divides the internal space of the outer package member 11 into the positive electrode compartment S1 and the negative electrode compartment S2. Accordingly, the positive electrode 12 and the negative electrode 13 are separated from each other with the partition 15 interposed therebetween, and are opposed to each other with the partition 15 interposed therebetween.

The partition 15 does not allow an anion to pass therethrough and allows a substance such as the lithium ion (a cation) other than the anion, which is to be inserted into and extracted from each of the positive electrode 12 and the negative electrode 13, to pass therethrough, between the positive electrode compartment S1 and the negative electrode compartment S2. A reason for this is that this prevents mixing of the positive electrode electrolytic solution 16 and the negative electrode electrolytic solution 17 with each other. That is, the partition 15 allows the lithium ion to pass therethrough from the positive electrode compartment S1 to the negative electrode compartment S2, and allows the lithium ion to pass therethrough from the negative electrode compartment S2 to the positive electrode compartment S1.

Specifically, the partition 15 includes an ion exchange membrane, a solid electrolyte membrane, or both. The ion exchange membrane is a porous film that allows the lithium ion to pass therethrough, i.e., a positive ion exchange membrane. The solid electrolyte membrane has a lithium-ion conductive property. A reason for using such a membrane in the partition 15 is that a property of the partition 15 allowing the lithium ion to pass therethrough is thereby improved.

In particular, it is more preferable that the partition 15 include the ion exchange membrane than the solid electrolyte membrane. A reason for this is that this makes it easier for each of the aqueous solvent in the positive electrode electrolytic solution 16 and the aqueous solvent in the negative electrode electrolytic solution 17 to penetrate into the partition 15, which improves the lithium-ion conductive property inside the partition 15.

The positive electrode 12 is disposed in the positive electrode compartment S1, and allows the lithium ion to be inserted thereinto and extracted therefrom. The negative electrode 13 is disposed in the negative electrode compartment S2, and allows the lithium ion to be inserted thereinto and extracted therefrom. The negative electrode 13 includes the titanium-containing compound as the negative electrode active material, as described above.

The positive electrode electrolytic solution 16 and the negative electrode electrolytic solution 17 are each the aqueous electrolytic solution including the aqueous solvent. The positive electrode electrolytic solution 16 is contained in the positive electrode compartment S1, and the negative electrode electrolytic solution 17 is contained in the negative electrode compartment S2. The positive electrode electrolytic solution 16 and the negative electrode electrolytic solution 17 are therefore separated from each other with the partition 15 interposed therebetween in such a manner as not to be mixed with each other.

In other words, the positive electrode electrolytic solution 16 is contained in the positive electrode compartment S1, and is therefore in contact with the positive electrode 12 but not in contact with the negative electrode 13. In contrast, the negative electrode electrolytic solution 17 is contained in the negative electrode compartment S2, and is therefore in contact with the negative electrode 13 but not in contact with the positive electrode 12.

A pH of the positive electrode electrolytic solution 16 and a pH of the negative electrode electrolytic solution 17 are different from each other. Specifically, the negative electrode electrolytic solution 17 that is in contact with the negative electrode 13 has the pH that is higher than or equal to 11 as with the electrolytic solution 14 according to the first embodiment. In contrast, the positive electrode electrolytic solution 16 that is in contact with the positive electrode 12 has the pH that is lower than 11. As long as such a high-and-low relationship related to the pH is satisfied, a composition (e.g., a kind of the aqueous solvent and a kind and a concentration of the ionic material) of each of the positive electrode electrolytic solution 16 and the negative electrode electrolytic solution 17 may be set as desired.

A reason why the positive electrode electrolytic solution 16 has the pH that is lower than 11 and the negative electrode electrolytic solution 17 has the pH that is higher than or equal to 11 is that a decomposition potential of the aqueous solvent shifts owing to the pH difference, as compared with, for example, a case where the pHs are the same as each other. This widens a potential window of the aqueous solvent while thermodynamically suppressing a decomposition reaction of the aqueous solvent upon charging and discharging. Accordingly, the charging and discharging reactions utilizing insertion and extraction of the lithium ion proceed sufficiently and stably while a high voltage is obtained.

In particular, it is preferable that a composition formula (i.e., a kind of the electrolyte salt) of the negative electrode electrolytic solution 17 be different from a composition formula (i.e., a kind of the electrolyte salt) of the positive electrode electrolytic solution 16. A reason for this is that this makes it easier to satisfy the above-described high-and-low relationship related to the pH.

As long as the above-described high-and-low relationship related to the pH is satisfied, the value of the pH of each of the positive electrode electrolytic solution 16 and the negative electrode electrolytic solution 17 is not particularly limited.

In particular, the pH of the negative electrode electrolytic solution 17 is preferably higher than or equal to 12, and more preferably higher than or equal to 13. A reason for this is that this allows the negative electrode electrolytic solution 17 to have a sufficiently high pH, therefore making it easier to satisfy the high-and-low relationship related to the pH. Another reason is that this provides a sufficiently large difference between the pH of the positive electrode electrolytic solution 16 and the pH of the negative electrode electrolytic solution 17, therefore making it easier to maintain the high-and-low relationship between the pHs of the two electrolytic solutions.

The pH of the positive electrode electrolytic solution 16 is preferably within a range from 3 to 8 both inclusive, more preferably within a range from 4 to 8 both inclusive, and still more preferably within a range from 4 to 6 both inclusive. A reason for this is that this provides a sufficiently large difference between the pH of the positive electrode electrolytic solution 16 and the pH of the negative electrode electrolytic solution 17, therefore making it easier to maintain the high-and-low relationship between the pHs of the two electrolytic solutions. Another reason is that this suppresses corrosion of the outer package member 11, and also suppresses corrosion of a battery component member such as the positive electrode current collector 12A or the negative electrode current collector 13A, therefore improving electrochemical durability or stability of the lithium-ion secondary battery.

Note that the positive electrode electrolytic solution 16, the negative electrode electrolytic solution 17, or each of the positive electrode electrolytic solution 16 and the negative electrode electrolytic solution 17 is preferably a saturated solution of the electrolyte salt (the lithium salt), as with the electrolytic solution 14 according to an embodiment. A reason for this is that the charging and discharging reactions, i.e., the insertion and extraction reactions of the lithium ion, proceed stably upon charging and discharging. A method of checking whether the positive electrode electrolytic solution 16 and the negative electrode electrolytic solution 17 are each the saturated solution of the lithium salt is similar to the method of checking whether the electrolytic solution 14 is the saturated solution of the lithium salt.

In the lithium-ion secondary battery, a physical property of the negative electrode 13 is made appropriate in order to achieve a superior charge and discharge characteristic, as with the above-described lithium-ion secondary battery according to the first embodiment. In other words, based on a surface analysis of each of the negative electrode active material layer 13B and the negative electrode current collector 13A by XPS, the element proportion A is greater than or equal to 99 atom %. In this case, it is preferable that the element proportion B be also greater than or equal to 99 atom %.

Upon charging the lithium-ion secondary battery, when the lithium ion is extracted from the positive electrode 12, the extracted lithium ion moves through the positive electrode electrolytic solution 16, the partition 15, and the negative electrode electrolytic solution 17, to the negative electrode 13. Thus, the lithium ion is inserted into the negative electrode 13.

Upon discharging the lithium-ion secondary battery, when the lithium ion is extracted from the negative electrode 13, the extracted lithium ion moves through the negative electrode electrolytic solution 17, the partition 15, and the positive electrode electrolytic solution 16, to the positive electrode 12. Thus, the lithium ion is inserted into the positive electrode 12.

A procedure for manufacturing the lithium-ion secondary battery is similar to the procedure for manufacturing the lithium-ion secondary battery according to an embodiment described above except for those described below.

In a case of preparing each of the positive electrode electrolytic solution 16 and the negative electrode electrolytic solution 17, the ionic material is added to the aqueous solvent. In this case, conditions including, without limitation, the kind and the concentration (mol/kg) of the ionic material are adjusted to thereby set the pH of the positive electrode electrolytic solution 16 to be lower than 11 and set the pH of the negative electrode electrolytic solution 17 to be higher than or equal to 11.

In a case of assembling the lithium-ion secondary battery, first, the outer package member 11 to which the partition 15 is attached in advance is prepared. The outer package member 11 has the positive electrode compartment S1 and the negative electrode compartment S2. Thereafter, the positive electrode 12 is placed inside the positive electrode compartment S1, and the coupling terminal part 12AT is led out of the positive electrode compartment S1. Further, the negative electrode 13 is placed inside the negative electrode compartment S2, and the coupling terminal part 13AT is led out of the negative electrode compartment S2. Lastly, the positive electrode electrolytic solution 16 is supplied into the positive electrode compartment S1 through an unillustrated positive electrode injection hole that is in communication with the positive electrode compartment S1, and the negative electrode electrolytic solution 17 is supplied into the negative electrode compartment S2 through an unillustrated negative electrode injection hole that is in communication with the negative electrode compartment S2. Thereafter, the positive electrode injection hole and the negative electrode injection hole are each sealed. Thus, the positive electrode electrolytic solution 16 is contained in the positive electrode compartment S1 in which the positive electrode 12 is disposed, and the negative electrode electrolytic solution 17 is contained in the negative electrode compartment S2 in which the negative electrode 13 is disposed. As a result, the lithium-ion secondary battery including two aqueous electrolytic solutions (i.e., the positive electrode electrolytic solution 16 and the negative electrode electrolytic solution 17) is completed.

According to the lithium-ion secondary battery, the negative electrode active material included in the negative electrode 13 includes the titanium-containing compound, the positive electrode electrolytic solution 16 including the aqueous solvent has the pH that is lower than 11, the negative electrode electrolytic solution 17 including the aqueous solvent has the pH that is higher than or equal to 11, and the element proportion A is greater than or equal to 99 atom %. Accordingly, it is possible to achieve a superior charge and discharge characteristic for a reason similar to the reason described above regarding the lithium-ion secondary battery according to an embodiment.

Other action and effects related to the lithium-ion secondary battery are similar to other action and effects related to the lithium-ion secondary battery according to an embodiment described above.

The configuration of the lithium-ion secondary battery is appropriately modifiable including as described below according to an embodiment. Note that any two or more of the following series of modifications may be combined with each other.

In an embodiment, the negative electrode 13 includes the negative electrode current collector 13A and the negative electrode active material layer 13B. However, the negative electrode 13 may exclude the negative electrode current collector 13A (except for the coupling terminal part 13AT), and may thus include only the negative electrode active material layer 13B. In this case, in the surface analysis of the negative electrode 13 by XPS, the surface of the negative electrode active material layer 13B is analyzed at any 10 points to thereby calculate the element proportion A.

In this case also, the above-described appropriate condition related to the element proportion A is satisfied, and similar effects are thus achievable.

In an embodiment, the negative electrode active material layer 13B is formed by a coating method. That is, in the process of forming the negative electrode active material layer 13B, the paste negative electrode mixture slurry is applied on the two opposed surfaces of the negative electrode current collector 13A, following which the applied negative electrode mixture slurry is dried. The paste negative electrode mixture slurry includes: the negative electrode active material including the titanium-containing compound; the negative electrode binder; and the negative electrode conductor.

However, the negative electrode active material layer 13B may be formed by a sintering method instead of the coating method. That is, in the process of forming the negative electrode active material layer 13B, the application of the negative electrode mixture slurry may be performed and the applied negative electrode mixture slurry may be dried, following which the dried negative electrode mixture slurry may be fired at a high temperature. As a result, the negative electrode active material in the negative electrode mixture slurry is sintered, and the negative electrode active material layer 13B is thus formed.

Specifically, the negative electrode active material including the titanium-containing compound is mixed with a material including, without limitation, polyethylene oxide which is the negative electrode binder to thereby obtain the negative electrode mixture. Thereafter, the negative electrode mixture is put into the solvent to thereby prepare the paste negative electrode mixture slurry. Thereafter, the application of the negative electrode mixture slurry is performed, following which the negative electrode mixture slurry is fired in an oxygen atmosphere. A firing temperature is not particularly limited, and is specifically within a range from 500° C. to 1200° C. both inclusive. A firing time is not particularly limited, and may thus be set as desired. As a result, the negative electrode active material in the negative electrode mixture slurry is sintered and the sintered negative electrode active material is fixed to the surface of the negative electrode current collector 13A. Thus, the negative electrode active material layer 13B is formed.

Note that, in the case of forming the negative electrode active material layer 13B is formed by the sintering method, the negative electrode binder, the negative electrode conductor, or both may not necessarily be included in the negative electrode mixture slurry. A reason for this is that the negative electrode active material is sintered in the case of using the sintering method, and this allows the negative electrode active material to be fixed to the negative electrode current collector 13A even if the negative electrode binder is not included, and an electric conductive property of the negative electrode active material layer 13B is ensured even if the negative electrode conductor is not included.

In this case also, the above-described appropriate condition related to the element proportion A is satisfied, and similar effects are thus achievable.

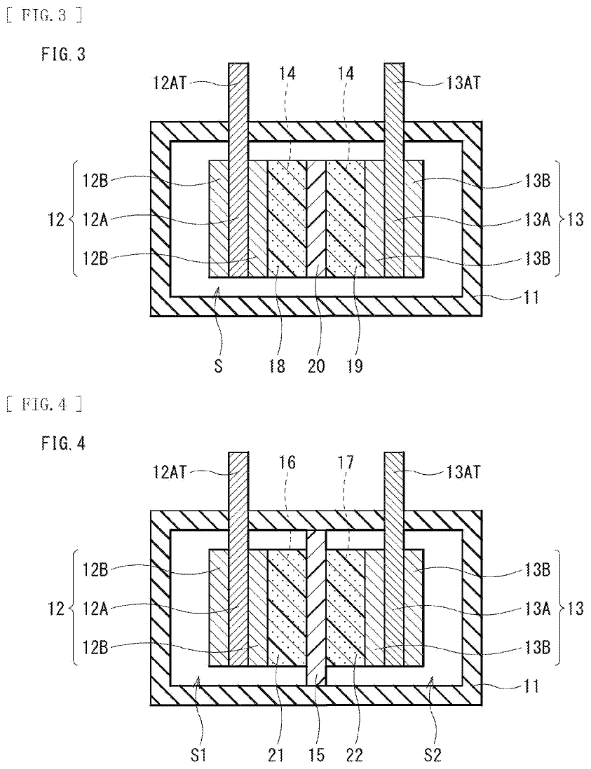

In an embodiment, the electrolytic solution 14 which is a liquid electrolyte is used, as illustrated in FIG. 1. However, as illustrated in FIG. 3 corresponding to FIG. 1, electrolyte layers 18 and 19 may be used instead of the electrolytic solution 14. The electrolyte layers 18 and 19 are gel electrolytes. A configuration of a lithium-ion secondary battery illustrated in FIG. 3 is similar to the configuration of the lithium-ion secondary battery illustrated in FIG. 1 except for those described below.

Here, the lithium-ion secondary battery further includes a separator 20, and the separator 20 is interposed between the electrolyte layers 18 and 19. Thus, the electrolyte layer 18 is disposed between the positive electrode 12 and the separator 20, and the electrolyte layer 19 is disposed between the negative electrode 13 and the separator 20. In other words, the electrolyte layer 18 is adjacent to each of the positive electrode 12 and the separator 20, and the electrolyte layer 19 is adjacent to each of the negative electrode 13 and the separator 20.

Specifically, the electrolyte layers 18 and 19 each include the electrolytic solution 14 and a polymer compound, and the electrolytic solution 14 is held by the polymer compound. The polymer compound is not limited to a particular kind, and specifically includes one or more of materials including, without limitation, polyvinylidene difluoride and polyethylene oxide. In FIG. 3, the electrolyte layers 18 and 19 are each lightly shaded.

The separator 20 is an insulating porous film that allows a lithium ion to pass therethrough, while separating the electrolyte layers 18 and 19 from each other, and includes a polymer compound such as polyethylene.

In a case of forming the electrolyte layer 18, the electrolytic solution 14, the polymer compound, and a solvent are mixed with each other to thereby prepare a precursor solution in a sol form, following which the precursor solution is applied on the surface of the positive electrode 12. A procedure for forming the electrolyte layer 19 is similar to the procedure for forming the electrolyte layer 18 except that the precursor solution is applied on the surface of the negative electrode 13.

In this case also, the lithium ion is movable between the positive electrode 12 and the negative electrode 13 via the electrolyte layers 18 and 19. Accordingly, it is possible to achieve effects similar to those of the case illustrated in FIG. 1.

In an embodiment, the positive electrode electrolytic solution 16 and the negative electrode electrolytic solution 17 which are liquid electrolytes are used, as illustrated in FIG. 2. However, as illustrated in FIG. 4 corresponding to FIG. 2, electrolyte layers 21 and 22 may be used instead of the positive electrode electrolytic solution 16 and the negative electrode electrolytic solution 17. The electrolyte layers 21 and 22 are gel electrolytes. A configuration of a lithium-ion secondary battery illustrated in FIG. 4 is similar to the configuration of the lithium-ion secondary battery illustrated in FIG. 2 except for those described below.

Here, the electrolyte layer 21 is disposed between the positive electrode 12 and the partition 15, and the electrolyte layer 22 is disposed between the negative electrode 13 and the partition 15. In other words, the electrolyte layer 21 is adjacent to each of the positive electrode 12 and the partition 15, and the electrolyte layer 22 is adjacent to each of the negative electrode 13 and the partition 15.

Specifically, the electrolyte layer 21 includes the positive electrode electrolytic solution 16 and a polymer compound, and the positive electrode electrolytic solution 16 is held by the polymer compound. The electrolyte layer 22 includes the negative electrode electrolytic solution 17 and a polymer compound, and the negative electrode electrolytic solution 17 is held by the polymer compound. Details of the kinds of the polymer compound are as described above. In FIG. 4, the electrolyte layer 21 including the positive electrode electrolytic solution 16 is lightly shaded, and the electrolyte layer 22 including the negative electrode electrolytic solution 17 is darkly shaded.

In a case of forming the electrolyte layer 21, the positive electrode electrolytic solution 16, the polymer compound, and a solvent are mixed with each other to thereby prepare a precursor solution in a sol form, following which the precursor solution is applied on the surface of the positive electrode 12. In a case of forming the electrolyte layer 22, the negative electrode electrolytic solution 17, the polymer compound, and a solvent are mixed with each other to thereby prepare a precursor solution in a sol form, following which the precursor solution is applied on the surface of the negative electrode 13.

In this case also, the lithium ion is movable between the positive electrode 12 and the negative electrode 13 via the electrolyte layers 21 and 22. Accordingly, it is possible to achieve effects similar to those of the case illustrated in FIG. 4.

Applications (application examples) of the lithium-ion secondary battery are not particularly limited. The lithium-ion secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the lithium-ion secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one lithium-ion secondary battery, or may each use multiple lithium-ion secondary batteries.

The battery pack may include a single battery, or may include an assembled battery. The electric vehicle is a vehicle that operates (travels) using the lithium-ion secondary battery as a driving power source, and may be a hybrid automobile that is additionally provided with a driving source other than the lithium-ion secondary battery. In an electric power storage system for home use, electric power accumulated in the lithium-ion secondary battery which is an electric power storage source may be utilized for using, for example, home appliances.

Needless to say, the lithium-ion secondary battery may have applications other than the series of applications described here as examples.

### EXAMPLES

Examples of the present technology are described below according to an embodiment.

### Examples 1 to 6 and Comparative Examples 1 to 3

As described below, lithium-ion secondary batteries were manufactured, following which the lithium-ion secondary batteries were each evaluated for a battery characteristic.

### [Manufacturing of Lithium-Ion Secondary Battery]

The lithium-ion secondary batteries each including one aqueous electrolytic solution (the electrolytic solution 14) illustrated in FIG. 1 were manufactured in accordance with the following procedure.

### (Fabrication of Positive Electrode)

First, 91 parts by mass of the positive electrode active material (LiFePO₄ (LFP) which is the lithium phosphoric acid compound), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into the solvent (N-methyl-2-pyrrolidone which is the organic solvent), following which the solvent was stirred to thereby prepare a paste positive electrode mixture slurry. Lastly, the positive electrode mixture slurry was applied on the two opposed surfaces of the positive electrode current collector 12A (a titanium foil having a thickness of 10 μm) excluding the coupling terminal part 12AT by means of a coating apparatus, following which the applied positive electrode mixture slurry was dried to thereby form the positive electrode active material layers 12B. Thus, the positive electrode 12 was fabricated.

### (Fabrication of Negative Electrode)

In each of Examples 1 to 5, the negative electrode active material layer 13B was formed by a coating method. In this case, first, 89 parts by mass of the negative electrode active material (the titanium-containing compound), and 11 parts by mass of the negative electrode binder (polyvinylidene difluoride) were mixed with each other to thereby obtain a negative electrode mixture. Further, 89 parts by mass of the negative electrode active material (the titanium-containing compound), 10 parts by mass of the negative electrode binder (polyvinylidene difluoride), and 1 part by mass of the negative electrode conductor (carbon black (CB) which is the carbon material) were mixed with each other to thereby obtain another negative electrode mixture.

Used as the titanium-containing compound were: titanium oxide (TiO₂) of the anatase type which is the titanium oxide; the lithium-titanium composite oxide (Li₄Ti₅O₁₂ (LTO)); and the lithium-titanium composite oxide whose surface was covered with a carbon layer (the carbon covering layer) which is the carbon material (Li₄Ti₅O₁₂ (CLTO)).

Thereafter, the negative electrode mixture was put into the solvent (N-methyl-2-pyrrolidone which is the organic solvent), following which the solvent was stirred to thereby prepare a paste negative electrode mixture slurry. Lastly, the negative electrode mixture slurry was applied on the two opposed surfaces of the negative electrode current collector 13A (a titanium (Ti) foil having a thickness of 10 μm) excluding the coupling terminal part 13AT by means of a coating apparatus, following which the applied negative electrode mixture slurry was dried to thereby form the negative electrode active material layers 13B. Thus, the negative electrode 13 was fabricated.

In Example 6, the negative electrode active material layer 13B was formed by a sintering method. In this case, first, 89 parts by mass of the negative electrode active material (titanium oxide of the anatase type which is the titanium-containing compound), and 11 parts by mass of the negative electrode binder (polyethylene oxide) were mixed with each other to thereby obtain a negative electrode mixture. Thereafter, the negative electrode mixture was put into the solvent (pure water which is the aqueous solvent) together with a surface active agent, following which the solvent was stirred to thereby prepare a paste negative electrode mixture slurry. Thereafter, the negative electrode mixture slurry was applied on the two opposed surfaces of the negative electrode current collector 13A (a titanium foil having a thickness of 10 μm) excluding the coupling terminal part 13AT by means of a coating apparatus, following which the applied negative electrode mixture slurry was dried. Lastly, the negative electrode mixture slurry was fired in an oxygen atmosphere (at a firing temperature of 700° C. and for a firing time of 1 hour) to thereby form the negative electrode active material layers 13B. Thus, the negative electrode 13 was fabricated.

The carbon proportion C (wt %) of the negative electrode 13 was as listed in Table 1. Further, the surface analysis of the negative electrode 13 (i.e., each of the negative electrode current collector 13A and the negative electrode active material layer 13B) was performed by XPS, following which the element proportions A and B (atom %) were calculated by the above-described analysis software on the basis of the result of the surface analysis. The results thereof are presented in Table 1.

### (Preparation of Electrolytic Solution)

The ionic material was put into the aqueous solvent (pure water), following which the aqueous solvent was stirred to thereby prepare the electrolytic solution 14. The kind of the ionic material, and the concentration (mol/kg) and the pH of the electrolytic solution 14 were as listed in Table 1. In this case, the pH of the electrolytic solution 14 was set to be higher than or equal to 11. Used as the ionic material were lithium hydroxide (LiOH) and lithium carbonate (Li₂CO₃) which are each the electrolyte salt (the lithium salt).

### (Assembly of Lithium-Ion Secondary Battery)

First, the positive electrode 12 and the negative electrode 13 were each placed in the internal space S of the outer package member 11 including glass (a glass beaker). In this case, the coupling terminal parts 12AT and 13AT were each led out of the outer package member 11. Thereafter, a reference electrode (a silver-silver chloride electrode) was disposed in the internal space S. Lastly, the electrolytic solution 14 was supplied into the internal space S. Thus, the electrolytic solution 14 was contained in the internal space S. As a result, the lithium-ion secondary battery was completed.

### [Manufacturing of Lithium-Ion Secondary Battery for Comparison]

The lithium-ion secondary batteries were manufactured by a similar procedure except that an aluminum (Al) foil and a copper (Cu) foil were used as the negative electrode current collector 13A. Further, the lithium-ion secondary battery was manufactured by a similar procedure except that the pH of the electrolytic solution 14 was set to be lower than 11 by using lithium nitrate (LiNO₃) as the ionic material. The kind of the ionic material, and the concentration (mol/kg) and the pH of the electrolytic solution 14 were as listed in Table 1.

### [Evaluation of Battery Characteristic]

The lithium-ion secondary batteries were each evaluated for a charge and discharge characteristic (chargeability and dischargeability, and charge and discharge efficiency) as a battery characteristic. The evaluation results are presented in Table 1.

In a case of examining the chargeability and dischargeability, whether the lithium-ion secondary battery was able to be charged and discharged, that is, whether both the charge capacity and the discharge capacity were obtainable, was checked.

In a case where the lithium-ion secondary battery was able to be charged and discharged, the charge and discharge efficiency was calculated on the basis of the following calculation expression: charge and discharge efficiency (%)=(discharge capacity/charge capacity)×100.

Here, in a case where the titanium oxide was used as the negative electrode active material, the lithium-ion secondary battery was charged with a constant current of 1 C until a voltage reached −1.3 V and discharged with a constant current of 1 C until the voltage reached −1.0 V, following which the lithium-ion secondary battery was discharged with the constant voltage of −1.0 V until a current reached 0.1 C. Note that 1 C is a value of a current that causes a battery capacity (a theoretical capacity) to be completely discharged in 1 hour, and 0.1 C is a value of a current that causes the battery capacity to be completely discharged in 10 hours.

Further, in a case where the lithium-titanium composite oxide was used as the negative electrode active material, the lithium-ion secondary battery was charged with a constant current of 1 C until a voltage reached −1.65 V and discharged with a constant current of 1 C until the voltage reached −1.35 V, following which the lithium-ion secondary battery was discharged with the constant voltage of −1.35 V until a current reached 0.1 C.

TABLE 1

| | Positive | | | | | | | | | | |
|---|---|---|---|---|---|---|---|---|---|---|---|
| | electrode | Negative electrode | | | | | | | | | Charge |
| | Positive | Negative | Negative | | | | | | | | and |
| | electrode | electrode | electrode | Negative | Element | Element | Carbon | Electrolytic solution | | | discharge |
| | active | current | active | electrode | proportion | proportion | proportion | Ionic | Concentration | | efficiency |
| | material | collector | material | conductor | A (atom %) | B (atom %) | C (wt %) | material | (mol/kg) | pH | (%) |
| Example 1 | LFP | Ti | TiO₂ | | 99 | 99 | 0 | LiOH | 4 | 12 | 80 |
| Example 2 | LFP | Ti | TiO₂ | | 99 | 99 | 0 | Li₂CO₃ | 0.1 | 11 | 70 |
| Example 3 | LFP | Ti | LTO | | 99 | 99 | 0 | LiOH | 4 | 12 | 50 |
| Example 4 | LFP | Ti | TiO₂ | CB | 99 | 99 | 3.0 | LiOH | 4 | 12 | 35 |
| Example 5 | LFP | Ti | CLTO | | 99 | 99 | 0.1 | LiOH | 4 | 12 | 25 |
| Example 6 | LFP | Ti | TiO₂ | | 99 | 99 | 0 | LiOH | 4 | 12 | 83 |
| Comparative | LFP | Al | TiO₂ | CB | 88 | 88 | 3.0 | LiOH | 4 | 12 | N/A |
| example 1 | | | | | | | | | | | |
| Comparative | LFP | Cu | TiO₂ | | 89 | 89 | 0 | LiOH | 4 | 12 | 10 |
| example 2 | | | | | | | | | | | |
| Comparative | LFP | Ti | TiO₂ | | 99 | 99 | 0 | LiNOs | 1 | 5 | N/A |
| example 3 | | | | | | | | | | | |

As indicated in Table 1, the charge and discharge efficiency varied depending on the physical property (i.e., the element proportion A) of the negative electrode 13 and the physical property (i.e., the pH) of the electrolytic solution 14.

Specifically, the pH of the electrolytic solution 14 was higher than or equal to 11, but the element proportion A was less than 99 atom % due to the use of, as a material to be included in the negative electrode current collector 13A, the metal material including the metal elements (Al and Cu) that were included in the non-particular metal material (Comparative examples 1 and 2). In such a case, the lithium-ion secondary battery was unable to be charged and discharged, or the charge and discharge efficiency decreased markedly even if the lithium-ion secondary battery was able to be charged and discharged.

Further, the element proportion A was greater than or equal to 99 atom % owing to the use of, as a material to be included in the negative electrode current collector 13A, the metal material including the metal element (Ti) that was included in the particular metal material, but the pH of the electrolytic solution 14 was lower than 11 (Comparative example 3). In such a case, the lithium-ion secondary battery was unable to be charged and discharged.

In contrast, the element proportion A was greater than or equal to 99 atom % owing to the use of, as a material to be included in the negative electrode current collector 13A, the metal material including the metal element (Ti) that was included in the particular metal material, and the pH of the electrolytic solution 14 was higher than or equal to 11 (Examples 1 to 6). In such a case, the lithium-ion secondary battery was able to be charged and discharged, and the charge and discharge efficiency increased.

In this case, the tendencies described below were obtained, in particular. First, in a case where the element proportion B was greater than or equal to 99 atom %, high charge and discharge efficiency was obtained. Second, in a case where the carbon proportion C was less than 0.1 atom %, the charge and discharge efficiency further increased. Third, in a case where the concentration of the electrolytic solution 14 was within the range from 0.2 mol/kg to 4 mol/kg both inclusive, the charge and discharge efficiency further increased. Fourth, in a case where the titanium oxide (titanium oxide of the anatase type) was used as the negative electrode active material, the charge and discharge efficiency further increased.

Based upon the results presented in Table 1, the lithium-ion secondary battery was able to be charged and discharged, and the high charge and discharge efficiency was obtained in a case where: the negative electrode active material of the negative electrode 13 included the titanium-containing compound; the electrolytic solution 14 including the aqueous solvent had the pH that was higher than or equal to 11; and the element proportion A was greater than or equal to 99 atom %. The lithium-ion secondary battery therefore achieved a superior charge and discharge characteristic.

Although the configuration of the lithium-ion secondary battery of the present technology has been described herein according to one or more embodiments including Examples, the configuration of the lithium-ion secondary battery of the present technology is not limited thereto, and is therefore modifiable in a variety of suitable ways.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A lithium-ion secondary battery comprising:
a positive electrode which a lithium ion is to be inserted into and extracted from;
a negative electrode including a negative electrode active material which the lithium ion is to be inserted into and extracted from; and
an electrolytic solution including an aqueous solvent, wherein
the negative electrode active material includes a titanium-containing compound,
the electrolytic solution has a pH that is higher than or equal to 11, and
based on a surface analysis of the negative electrode by X-ray photoelectron spectroscopy, a proportion of a sum of respective detectable amounts of lithium, titanium, tin, zirconium, bismuth, and indium to a sum of respective detectable amounts of all of metal elements is greater than or equal to 99 atomic percent.

2. The lithium-ion secondary battery according to claim 1, wherein, based on the surface analysis of the negative electrode by the X-ray photoelectron spectroscopy, a proportion of a sum of the respective detectable amounts of lithium and titanium to the sum of the respective detectable amounts of all of the metal elements is greater than or equal to 99 atomic percent.

3. The lithium-ion secondary battery according to claim 1, wherein
the negative electrode further includes a carbon material, and
a proportion of a weight of the carbon material to a weight of the negative electrode is less than 0.1 weight percent.

4. The lithium-ion secondary battery according to, wherein a concentration of the electrolytic solution is greater than or equal to 0.2 moles per kilogram and less than or equal to 4 moles per kilogram.

5. The lithium-ion secondary battery according to claim 1, wherein the titanium-containing compound includes at least one selected from the group of a titanium oxide represented by Formula (1) and respective lithium-titanium composite oxides represented by Formulae (2) to (4),
TiO_{w} (1)
where w satisfies 1.85≤w≤2.15,
Li[LiₓM1_{(1-3x)/2}Ti_{(3+x)/2}]O₄ (2)
where
M1 is at least one of Mg, Ca, Cu, Zn, or Sr, and
x satisfies 0≤x≤⅓,
Li[Li_{y}M2_{1-3y}Ti_{1+2y}]O₄ (3)
where
M2 is at least one of Al, Sc, Cr, Mn, Fe, Ge, or Y, and
y satisfies 0≤y≤⅓,
Li[Li_{1/3}M3_{z}Ti_{(5/3)-z}]O₄ (4)
where
M3 is at least one of V, Zr, or Nb, and
z satisfies 0≤z≤⅔.

6. The lithium-ion secondary battery according to claim 5, wherein the titanium oxide includes titanium oxide of an anatase type.

7. The lithium-ion secondary battery according to claim 1, wherein
the negative electrode includes a negative electrode active material layer including the negative electrode active material, and
a surface of the negative electrode active material layer is analyzed by the X-ray photoelectron spectroscopy.

8. The lithium-ion secondary battery according to claim 7, wherein
the negative electrode further includes a negative electrode current collector that supports the negative electrode active material layer, and
the surface of the negative electrode active material layer and a surface of the negative electrode current collector are each analyzed by the X-ray photoelectron spectroscopy.

9. A lithium-ion secondary battery comprising:
a partition that is disposed between a positive electrode space and a negative electrode space, thereby allowing a lithium ion to pass therethrough;
a positive electrode that is disposed in the positive electrode space and which the lithium ion is to be inserted into and extracted from;
a negative electrode that is disposed in the negative electrode space and includes a negative electrode active material which the lithium ion is to be inserted into and extracted from;
a positive electrode electrolytic solution that is contained in the positive electrode space and includes an aqueous solvent; and
a negative electrode electrolytic solution that is contained in the negative electrode space and includes the aqueous solvent, wherein
the negative electrode active material includes a titanium-containing compound,
the positive electrode electrolytic solution has a pH that is lower than 11,
the negative electrode electrolytic solution has a pH that is higher than or equal to 11, and
based on a surface analysis of the negative electrode by X-ray photoelectron spectroscopy, a proportion of a sum of respective detectable amounts of lithium, titanium, tin, zirconium, bismuth, and indium to a sum of respective detectable amounts of all of metal elements is greater than or equal to 99 atomic percent.
